(19) United States
(12) Patent Application Publication
(10) Pub. No.: US 2001/0055922 A1
(43) Pub. Date: Dec. 27, 2001

(54) Connector, particularly for airbag ignition systems

(76) Inventor: Bernhard Kuhnel, Altdorf (DE)

Correspondence Address: PERMAN & GREEN, 425 POST ROAD, FAIRFIELD, CT, 06430, US

(21) Appl. No.: 09/861,200

(22) Filed: May 18, 2001

(30) Foreign Application Priority Data
May 22, 2000 (DE) 10025295

(51) Int. Cl. H01R 13/66

(52) U.S. Cl. 439/877

(57) ABSTRACT

The invention relates to a connector, particularly for airbag ignition systems, comprising a casing (1, 2, 3) with a holder (4) for a flat conductor strip (10) and means for contacting it with contact ends (7), wherein the contacting means are metal strips (6), with crimp plates (9) formed on their first ends near the cable, an electric component being mounted around their central regions, and their second ends each being electrically connected to a connecting tongue of a contact end (7).

The invention relates to a connector, particularly for airbag ignition systems, comprising a casing with a holder for a flat conductor strip and means for contacting it with contact ends.

Connectors designed for use in airbag ignition systems must be compact and in particular must be flat, since there is very little space for installing them in a vehicle steering wheel. The connectors must also have space for filters for preventing electromagnetic interference from accidentally triggering the ignition system. The plugs must also be easy to wire, so that an airbag retaining system can be installed in as simple manner as possible. In the case of known connectors for airbag systems, the connector casing consists of two shells, the plug contact, filter and connecting pins for the lead being disposed in the bottom shell and the ends of the lead being welded to the connecting pins.

DE 42 17 205 A1 discloses a connector for airbag applications wired by means of a flat conductor strip, wherein contact pins extend through the individual strip conductors and electric contact is obtained by application of tin solder. As before, the use of tin solder has not been avoided, and complicated work is therefore needed on the semi-finished connector.

The object of the invention is to disclose a connector, particularly for airbag ignition systems, which can be delivered in a pre-assembled position and is easy to connect to a connecting cable.

According to the invention this problem is solved by the features in claim 1.

Features of preferred embodiments of the invention are specified in the sub-claims.

The invention will now be further explained by describing an exemplified embodiment with reference to the drawings, in which:

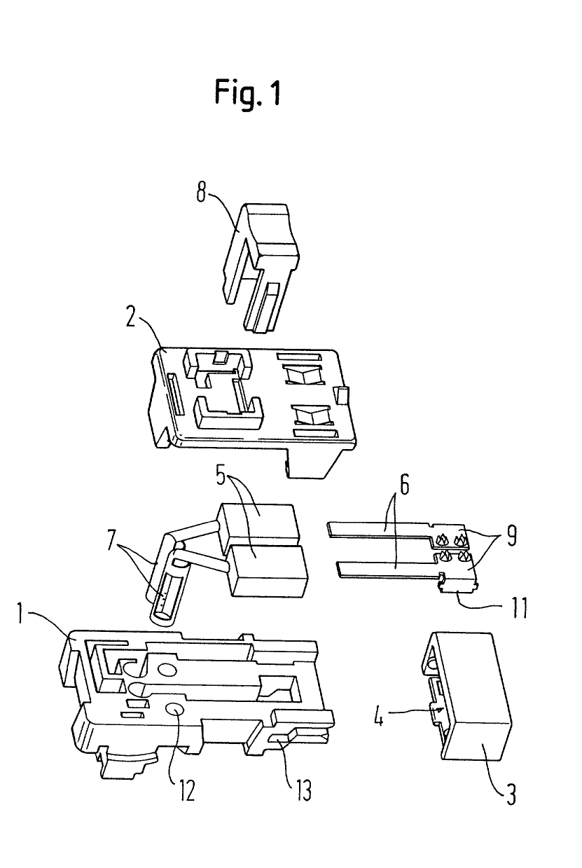

FIG. 1 is an exploded view of a connector according to the invention;

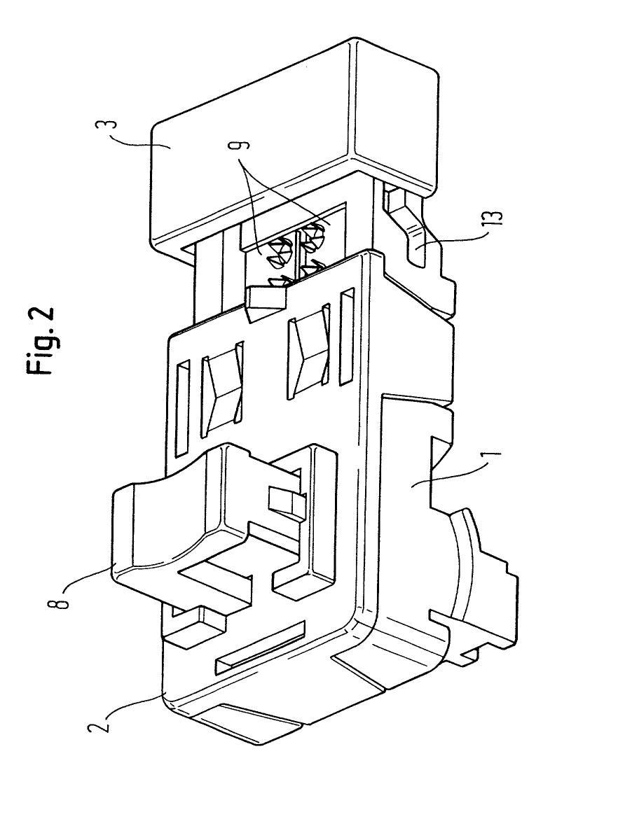

FIG. 2 shows a connector according to the invention in the pre-assembly position and

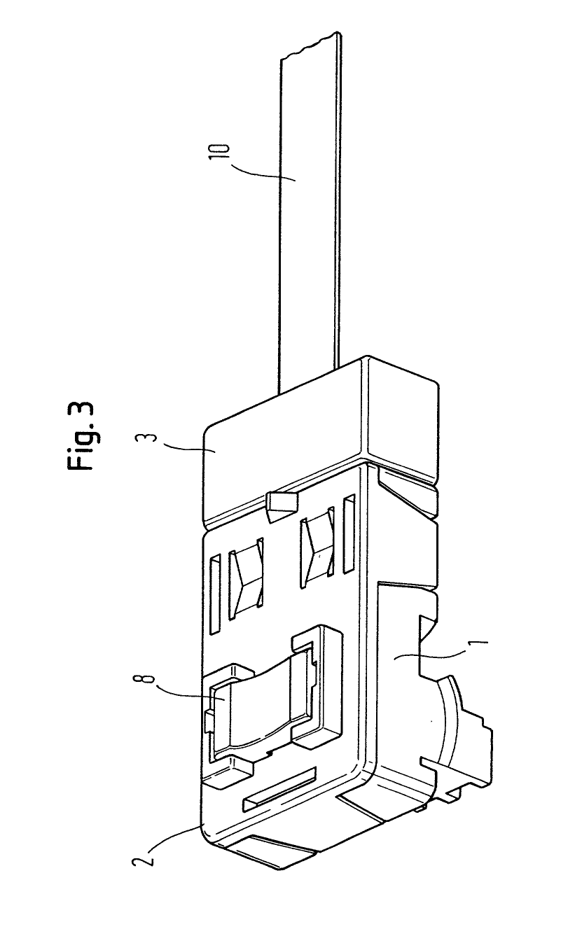

FIG. 3 shows a connector according to the invention with a connected flat conductor strip and engaged secondary locking means.

FIG. 1 shows the individual components of the connector according to the invention. The drawing shows a casing having a bottom part 1, a top part 2 and a rear top part 3. The rear top part 3 has a holder 4 in the form of a slit for a flat conductor strip (not shown), the end of which is inserted through the slit into the casing. Two metal strips 6 are provided for electrically connecting the flat conductor strip 10 to the metal strips, on each of which a ferrite choke is mounted. The front ends of the metal strips 6 project from the ferrite blocks 5, where they are electrically connected to tongues on the plug contacts 7. The inside of the bottom part of the casing is profiled so that the individual components (plug contacts 7, ferrite blocks 5 and metal strips 6) are mounted in a fixed position via their crimp plates 9. Passage openings 12 are provided for inserting e.g. a spot-welding head as far as the connecting place between the front ends of the metal strips 6 and the connecting tongues of the plug contact 7, for spot welding on the semi-installed connector. The first top part 2 of the casing is then mounted by engagement on the bottom part 1 and the secondary locking means 8 is also brought into a pre-engagement position.

FIG. 2 shows the connector according to the invention in the said pre-assembled position, where the rear top part 3 of the casing is already brought by a sliding block and groove locking means 13 into a position where the crimp plates 9 are accessible to a crimping tool for fastening the flat conductor strip 10 to the metal strips 6. After the flat conductor strip 10 has been crimped to the metal strips 6, the rear upper casing part is slid along the groove 13 into its final position. As FIG. 2 shows, the groove, viewed substantially in the closure direction, slopes downwards and has a means for locking in the end position, so that the rear upper casing part is pressed on to the flat conductor strip 10 and thus relieves the tension thereon.

For final assembly, the connector according to the invention is supplied in the pre-assembly position shown in FIG. 2 and can be connected to the flat conductor strip without soldering and also without opening the rest of the plug casing, with the result that final assembly is simpler and more reliable.

The preceding description of an exemplified embodiment of the invention is only for illustrating the invention specified in the claims and should in no way be regarded as limitative.

1. A connector, particularly for airbag ignition systems, comprising a casing (1, 2, 3) with a holder (4) for a flat conductor strip (10) and means for contacting it with contact ends (7), characterised in that the contacting means are metal strips (6),
with crimp plates (9) formed on their first ends near the cable,
an electric component being mounted around their central regions, and
their second ends each being electrically connected to a connecting tongue of a contact end (7).

2. A connector according to claim 1, characterised in that the electric component is a choke (5) made of ferrite or the like.

3. A connector according to claim 1, characterised in that the metal strips (6) have bent lugs (11) for fastening them in a bottom part (1) of the casing.

4. A connector according to claim 1, characterised in that at least one top part of the casing is fastened to the bottom part and covers the plug contact (7) and the ferrite choke (5).

5. A connector according to claim 4, characterised in that on its inside, the top part (2) of the casing has resilient projections level with the ferrite chokes (5) and pressing the ferrite chokes (5) on to the metal strips (6) in order to hold them in contact.

6. A connector according to claim 3, characterised in that passage openings for access e.g. of a spot welding head are disposed in the bottom part or top part of the casing level with the place where the connecting tongues and the second metal strip end are welded.

7. A connector according to claim 1, characterised in that the top part of the casing is fastened to the bottom part by locking lugs on the side walls.
